(19) United States
(12) Patent Application Publication
(10) Pub. No.: US 2026/0349432 A1
(43) Pub. Date: Nov. 5, 2026

(54) SELF-LEARNING SMARTPHONE BRISTLEBOT

(71) Applicant: Georgia Tech Research Corporation, Atlanta, GA (US)

(72) Inventor: Jun Ueda, Atlanta, GA (US)

(21) Appl. No.: 19/664,384

(22) Filed: Apr. 30, 2026

Related U.S. Application Data
(60) Provisional application No. 63/797,602, filed on Apr. 30, 2025.

(51) Int. Cl. G05D 1/46; G05D 1/222; G06T 7/20; G06T 7/70; G05D 109/12

(52) U.S. Cl. CPC G05D 1/46; G05D 1/222; G06T 7/20; G06T 7/70; G05D 2109/12

(57) ABSTRACT

The present disclosure relates generally to autonomous robotic systems, and more particularly to a self-learning smartphone-based bristlebot system utilizing vibration-induced locomotion, computer vision-based position tracking, and reinforcement learning for controlled movement. A self-learning robotic system includes a computing device including an actuator and a camera. A platform is mechanically coupled to the computing device, the platform including a plurality of leg structures extending therefrom, each leg structure terminating at a leg tip configured to contact a surface. The actuator is configured to generate vibrations at one or more actuation parameters, the vibrations being transmitted to the plurality of leg structures to induce locomotion of the system. The camera is configured to capture image data for tracking a location of the computing device during operation.

### CROSS-REFERENCE TO RELATED APPLICATIONS

This application claims the benefit of U.S. Provisional Application Serial No. 63/797,602, filed on 30 Apr. 2025, which is incorporated herein by reference in its entirety as if fully set forth below.

### FIELD OF INVENTION

The present disclosure relates to autonomous robotic systems, and more particularly to a self-learning smartphone-based bristlebot system utilizing vibration-induced locomotion, computer vision-based position tracking, and reinforcement learning for controlled movement.

### BACKGROUND

Vibration-induced locomotion systems, commonly known as bristlebots, represent a class of simple robotic devices that convert vibrational energy into directional movement. These systems typically comprise a vibration motor mounted on a platform with flexible leg structures, such as bristles, that interact with a surface to produce locomotion when the motor is activated. Bristlebots have been commercialized as toys and educational devices, demonstrating basic principles of vibration and motion. Smartphones and similar mobile computing devices contain various integrated components including vibration motors, cameras, and processors that enable a wide range of applications. These devices are widely available and provide accessible platforms for experimentation and education.

However, existing bristlebot systems suffer from several limitations. Conventional bristlebots lack the ability to achieve controlled, predictable movement patterns, as their locomotion behavior is largely determined by fixed mechanical properties and uncontrolled vibration characteristics. Present systems do not incorporate feedback mechanisms that would allow the device to learn or adapt its movement behavior based on observed outcomes. Additionally, existing approaches to controlling vibration-induced locomotion often require external tracking systems, such as external cameras, to monitor device position, which adds complexity and limits the accessibility and portability of such systems. The process of tuning vibration patterns to achieve desired movement behaviors in bristlebot systems has traditionally been a manual and time-consuming endeavor.

What is needed, therefore, is an improved system that enables autonomous, self-learning locomotion control for vibration-based robotic platforms. Such a system would integrate position tracking capabilities directly within the device, utilize machine learning techniques to automatically discover and optimize vibration patterns for achieving controlled movement, and leverage existing hardware components found in widely available computing devices to provide an accessible platform for robotics education and experimentation.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

A self-learning robotic system can include a computing device including an actuator and a camera. The system can include a platform mechanically coupled to the computing device, the platform including a plurality of leg structures extending therefrom, each leg structure terminating at a leg tip configured to contact a surface. The actuator can be configured to generate vibrations at one or more actuation parameters, the vibrations being transmitted to the plurality of leg structures to induce locomotion of the system. The camera can be configured to capture image data for tracking a location of the computing device during operation.

A method for controlling locomotion of a robotic system can include generating, by an actuator of a computing device, vibrations at one or more actuation parameters, the vibrations being transmitted to a plurality of leg structures of a platform mechanically coupled to the computing device to induce locomotion of the robotic system. The method can include capturing, by a camera of the computing device, image data during the locomotion. The method can include determining, by a processor of the computing device, a motion of the robotic system based on the image data. The method can include correlating the motion with the one or more actuation parameters. The method can include adjusting the one or more actuation parameters based on the correlation to achieve a desired locomotion.

A non-transitory computer-readable medium can store instructions that, when executed by a processor of a computing device, cause the computing device to control an actuator of the computing device to generate vibrations at one or more actuation parameters, the vibrations being transmitted to a plurality of leg structures of a platform mechanically coupled to the computing device to induce locomotion. The instructions can cause the computing device to receive image data from a camera of the computing device during the locomotion. The instructions can cause the computing device to determine a motion of the computing device based on the image data. The instructions can cause the computing device to correlate the motion with the one or more actuation parameters. The instructions can cause the computing device to adjust the one or more actuation parameters based on the correlation to achieve a desired locomotion.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a cross-sectional view of a self-learning robotic system having a smartphone disposed within a smartphone case with a leg structure, according to examples of the disclosed technology.

FIG. 2 illustrates an isometric view of leg structure for a smartphone case, according to examples of the disclosed technology.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The present disclosure describes a self-learning robotic system that can transform a computing device into an autonomous platform capable of vibration-induced locomotion, computer vision-based position tracking, and reinforcement learning for controlled movement. The system can integrate an actuator, a camera, and a platform with leg structures to achieve autonomous locomotion and learning capabilities.

In some aspects, the system can include a computing device comprising an actuator and a camera. A platform can be mechanically coupled to the computing device, with the platform including a plurality of leg structures extending therefrom. Each leg structure can terminate at a leg tip configured to contact a surface. The actuator can be configured to generate vibrations at one or more actuation parameters, and the vibrations can be transmitted to the plurality of leg structures to induce locomotion of the system. The camera can be configured to capture image data for tracking a location of the computing device during operation.

In some aspects, the system can leverage existing capabilities of the computing device, including the actuator, camera, and processing power, to create a platform for robotics experimentation. The system can integrate mechanical components, vision-based tracking, and machine learning to enable autonomous discovery and optimization of movement strategies. A processor of the computing device can be configured to determine a motion of the system based on image data captured by the camera, correlate the motion with the one or more actuation parameters, and adjust the one or more actuation parameters based on the correlation to achieve a desired locomotion.

In some cases, the system can implement a reinforcement learning approach to optimize the one or more actuation parameters for achieving controlled movement. The reinforcement learning approach can incorporate position, velocity, and vibration parameters in a state space, while an action space can manage frequency selection, amplitude modulation, and pattern timing. This framework can enable autonomous discovery and optimization of movement strategies through systematic experimentation.

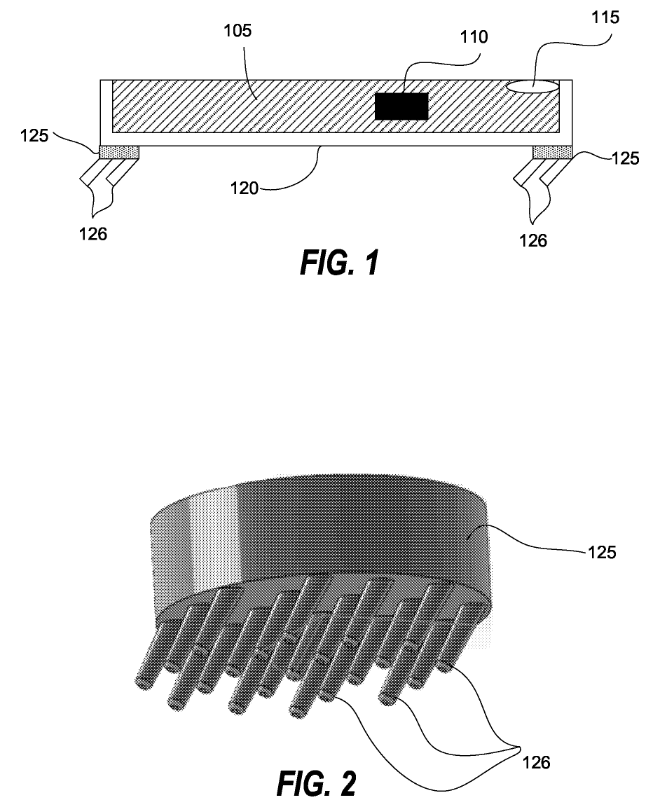

FIG. 1 illustrates a cross-sectional view of a self-learning robotic system according to examples of the disclosed technology. The self-learning robotic system can include a computing device comprising an actuator and a camera. A platform can be mechanically coupled to the computing device, with the platform comprising a plurality of leg structures extending therefrom. Each leg structure can terminate at a leg tip configured to contact a surface. The actuator can be configured to generate vibrations at one or more actuation parameters, and the vibrations can be transmitted to the plurality of leg structures to induce locomotion of the system. The camera can be configured to capture image data for tracking a location of the computing device during operation.

In some aspects, the computing device can comprise a smartphone 105, and the platform can comprise a smartphone case 120 configured to receive the smartphone 105. The smartphone case 120 can be referred to herein as a platform. As shown in FIG. 1, the smartphone 105 can be disposed within the smartphone case 120. The smartphone 105 can include a vibration motor 110 positioned within a body of the smartphone 105. The vibration motor 110 can be referred to herein as an actuator. In some cases, the actuator can comprise the vibration motor 110 of the smartphone 105. In some aspects, the vibration motor 110 can comprise a Taptic Engine driven by Core Haptics on iOS devices.

The smartphone 105 can include a camera 115 located near an upper surface of the smartphone 105. The camera 115 can be configured to capture image data for tracking a location of the smartphone 105 during operation. The smartphone case 120 can be mechanically coupled to the smartphone 105 and can provide structural support for the system.

The smartphone case 120 can include a leg structure 125 extending from each side of the smartphone case 120. Each leg structure 125 can terminate at a leg tip 126 configured to contact a surface. The leg structures 125 can be angled outward from the smartphone case 120, with the leg tips 126 positioned to engage with a supporting surface beneath the system. The vibration motor 110 can be configured to generate vibrations that are transmitted through the smartphone 105 and the smartphone case 120 to the leg structures 125, inducing locomotion of the system.

In some aspects, the smartphone case 120 can be designed to provide thermal management for the smartphone 105. The smartphone case 120 can also be designed to provide impact protection for the smartphone 105. The smartphone case 120 can preserve full access to all smartphone functions while maintaining alignment of components.

In some cases, the system can operate on a smooth level surface such as glass, sealed wood, or short-pile carpet. The leg tips 126 can interact with the surface to produce locomotion when the vibration motor 110 is activated.

FIG. 2 illustrates an isometric view of a leg structure for a smartphone case according to examples of the disclosed technology. The leg structure can comprise a cylindrical base portion configured to attach to a smartphone case. A plurality of leg tips can be arranged in a pattern across an underside of the leg structure. Each leg tip can comprise an elongated cylindrical member that extends downward and outward from the base portion at an angle. The leg tips can be configured to contact a surface during operation of the robotic system. The angled orientation of the leg tips can facilitate transmission of vibrations from an actuator to produce locomotion when the leg structure is attached to a platform mechanically coupled to a computing device.

A geometry of the plurality of leg structures can affect a type of locomotion produced in response to vibrations generated by the actuator. The plurality of leg structures can comprise at least one of straight leg structures, curved leg structures, angled leg structures, or branched leg structures. Straight leg structures can provide predictable sliding motion. Curved leg structures, such as forward-bent curved leg structures, can bias the system toward forward travel. Angled leg structures, such as splayed angled leg structures, can produce more rotation on each vibration pulse. Branched leg structures can enable more sophisticated motion patterns.

The plurality of leg structures can be configured to respond to predetermined vibrational frequencies to enable different types of movement. Each leg structure configuration can respond to specific vibration frequencies, creating a space of possible movements. The plurality of leg structures can be configured to exploit multiple resonant modes between 10 Hz and 300 Hz. In some cases, the leg structures can exploit multiple resonant modes between 10 Hz and 200 Hz.

In some aspects, a leg structure can have a length between 8 mm and 15 mm for basic straight bristle designs. The leg structure can be made from stiff bristles cut from a toothbrush. In some cases, the leg structure can be made from zip ties. In some aspects, the leg structure can be made from 1 mm wire. The leg structure can be attached to the smartphone case using double-sided tape. In some cases, the leg structure can be attached to the smartphone case using mounting putty.

The system can use two leg structures attached to the smartphone case. In some aspects, the system can use three leg structures attached to the smartphone case. In some cases, the system can use four leg structures attached to the smartphone case. The leg structures can be mounted symmetrically left-to-right on the smartphone case so the system has a neutral starting bias. The leg structures can be angled slightly outward so the smartphone rests stably face-up.

The smartphone case can be manufactured using various methods depending on production requirements and desired material properties. In some aspects, the smartphone case can be manufactured using three-dimensional (3D) printing techniques. 3D printing can enable rapid prototyping and iterative development of case and leg structure designs.

In some cases, the smartphone case can be manufactured using 3D printing with polylactic acid plus (PLA+) filament for rigid case structures. PLA+ filament can provide structural rigidity for the main body of the smartphone case. The rigid properties of PLA+ filament can enable efficient transmission of vibrations from the computing device to the leg structures.

In some aspects, the smartphone case can be manufactured using 3D printing with thermoplastic polyurethane (TPU) filament for flexible leg designs. TPU filament can provide flexibility for the leg structures, enabling the leg structures to respond to vibrations generated by the actuator. The flexible properties of TPU filament can allow the leg structures to deform and recover during vibration cycles, facilitating locomotion of the system.

In some cases, the smartphone case can be manufactured using 3D printing with polyethylene terephthalate glycol (PETG) filament. PETG filament can provide a combination of rigidity and impact resistance for the smartphone case. PETG filament can be used for components requiring durability and resistance to mechanical stress.

In some aspects, the smartphone case can be manufactured using injection molding for production at scale. Injection molding can enable production of both rigid and flexible components with consistent quality. An automated injection molding system can produce smartphone cases and leg structures at higher volumes than 3D printing methods. Injection molding can maintain dimensional accuracy and material properties across production runs. In some cases, the injection molding process can incorporate quality control systems to maintain product standards at scale.

The self-learning robotic system can include a vision system for tracking position and motion of the system during operation. As described above, the camera can be configured to capture image data for tracking a location of the computing device during operation. The camera can comprise a front-facing camera of the computing device. The image data can comprise images of a reference pattern positioned above the system. In some aspects, the reference pattern can comprise a checkerboard pattern positioned on a ceiling above the system. The checkerboard pattern can provide features for the vision system to track in each frame captured by the front-facing camera.

The system can include a vision module configured to process the image data to determine position and motion of the system. The vision module can use a hybrid approach combining optical flow analysis with feature-based tracking for reliable position determination. The hybrid approach can ensure reliable position determination under varying environmental conditions. In some cases, the vision module can use optical flow analysis to detect translation and rotation of the computing device based on changes in the image data between successive frames. In some aspects, the vision module can use feature-based tracking to identify and track features of the reference pattern across multiple frames.

The vision module can provide a confidence metric indicating tracking reliability. The confidence metric can have a value between 0 and 1. A higher confidence metric value can indicate more reliable tracking of the reference pattern. A lower confidence metric value can indicate that the reference pattern is not being tracked reliably. In some cases, the system can use the confidence metric to determine whether tracking conditions are suitable for operation.

The vision module can operate at a resolution of 720p and a frame rate of 30 frames per second. The vision system can deliver real-time position and motion tracking with sub-millimeter accuracy. In some aspects, the vision system can achieve tracking latency below 50 milliseconds. The processing pipeline of the vision module can begin with optimized frame acquisition, employing feature detection and tracking algorithms. The vision module can determine translation and rotation of the computing device based on the image data. The vision module can track cumulative translation of the computing device since an episode started.

The self-learning robotic system can include a computing device comprising a processor configured to execute instructions to control locomotion of the system. The processor can be configured to determine a motion of the system based on image data captured by the camera, correlate the motion with one or more actuation parameters, and adjust the one or more actuation parameters based on the correlation to achieve a desired locomotion.

The actuator can be configured to generate vibrations at one or more actuation parameters. The one or more actuation parameters can comprise at least one of a frequency, a duration, a magnitude, or a pattern timing of the vibrations. In some aspects, the one or more actuation parameters can comprise a combination of frequency, duration, magnitude, and pattern timing. The frequency can define a rate at which the actuator oscillates during vibration generation. The duration can define a length of time for which a vibration is generated. The magnitude can define an amplitude or intensity of the vibration. The pattern timing can define a sequence or schedule of vibration pulses over time.

In some cases, the actuator can comprise a Taptic Engine driven by Core Haptics on iOS devices. The Taptic Engine can be referred to herein as an actuator. Core Haptics can provide an application programming interface (API) for controlling the Taptic Engine to generate vibrations at specified frequencies and amplitudes. The Taptic Engine can generate vibrations across a range of frequencies, and the Core Haptics API can enable precise control over the frequency, amplitude, and timing of vibration pulses. In some aspects, the actuator can comprise a vibration motor on Android devices.

The processor can determine a motion of the system based on image data captured by the camera. The processor can receive image data from the camera during locomotion of the system. The processor can process the image data to determine translation and rotation of the computing device. In some cases, the processor can determine a velocity of the system based on changes in position between successive frames of image data. The processor can track cumulative translation of the computing device over time.

The processor can correlate the motion with the one or more actuation parameters. The correlation can establish a relationship between specific actuation parameters and resulting motion of the system. In some aspects, the processor can generate a frequency-to-motion map that associates each tested frequency with a corresponding motion response. The frequency-to-motion map can record how much and in which direction the computing device moved in response to each vibration frequency. The processor can store the correlation data for use in subsequent locomotion control.

The processor can adjust the one or more actuation parameters based on the correlation to achieve a desired locomotion. The desired locomotion can comprise forward movement, backward movement, turning left, turning right, or rotation in place. In some cases, the processor can select actuation parameters from the frequency-to-motion map that correspond to a desired direction of movement. The processor can modulate the frequency, duration, magnitude, or pattern timing of vibrations to achieve controlled movement toward a target location or orientation.

In some aspects, the processor can implement a closed-loop control system in which the camera continuously captures image data during locomotion, the processor determines motion based on the image data, and the processor adjusts actuation parameters in response to observed motion. The closed-loop control system can enable the system to correct for deviations from a desired trajectory. The processor can compare observed motion with desired motion and adjust actuation parameters to reduce the difference between observed and desired motion.

Different actuation parameters can produce different types of locomotion. In some cases, vibrations at a first frequency can produce forward movement, while vibrations at a second frequency can produce rotation. The relationship between actuation parameters and resulting motion can depend on a geometry of the plurality of leg structures and properties of a surface on which the system operates. The processor can learn the relationship between actuation parameters and motion through systematic experimentation.

In some aspects, the processor can adjust actuation parameters in real-time during locomotion to achieve a desired trajectory. The processor can receive a target location or orientation and can select and adjust actuation parameters to move the system toward the target. The processor can continuously monitor position and motion of the system through the camera and can make adjustments to actuation parameters as needed to maintain progress toward the target.

The self-learning robotic system can perform an exploration sweep to characterize the relationship between actuation parameters and resulting motion. The exploration sweep can comprise generating vibrations across a range of frequencies and recording a resulting motion for each frequency to generate a frequency-to-motion map.

In some aspects, the system can perform the exploration sweep across a vibration frequency range of 10 Hz to 300 Hz. The exploration sweep can be performed at two amplitudes to capture motion responses at different vibration intensities. During the exploration sweep, the actuator can generate vibrations at each frequency within the range, and the camera can capture image data to record the resulting motion of the system.

Each vibration command during the exploration sweep can be played for approximately one second while recording the resulting motion. The processor can determine translation and rotation of the computing device based on the image data captured during each vibration command. The processor can record how much and in which direction the computing device moved in response to each vibration frequency and amplitude combination.

In some cases, the exploration sweep can take approximately six minutes to complete. The duration of the exploration sweep can depend on the number of frequencies tested and the duration of each vibration command. During the exploration sweep, the system can drift across the surface as the leg structures respond to the vibrations generated by the actuator.

The frequency-to-motion map can associate each tested frequency and amplitude combination with a corresponding motion response. The frequency-to-motion map can record translation and rotation data for each vibration command tested during the exploration sweep. In some aspects, the processor can use the frequency-to-motion map to select actuation parameters that correspond to a desired direction of movement.

The frequency-to-motion map can be saved to a configuration file. The configuration file can be reloaded for the same leg structure and surface combination, allowing the system to skip the exploration sweep on subsequent uses. In some cases, the configuration file can be named based on the leg structure geometry and surface type. The system can maintain separate configuration files for different leg structure and surface combinations, enabling the system to load the appropriate frequency-to-motion map based on the current configuration.

The self-learning robotic system can include a processor configured to execute a reinforcement learning algorithm to optimize the one or more actuation parameters for achieving controlled movement. The reinforcement learning algorithm can comprise Proximal Policy Optimization (PPO). PPO can be selected for stability in continuous control tasks. The reinforcement learning algorithm can enable autonomous discovery and optimization of movement strategies through systematic experimentation.

In some aspects, the reinforcement learning algorithm can use a state space incorporating position, velocity, and vibration parameters. The state space can represent a current condition of the system at each time step during training. The position can comprise a location of the computing device as determined by the vision module based on image data captured by the camera. The velocity can comprise a rate of change of position of the computing device between successive frames of image data. The vibration parameters can comprise current or recent actuation parameters applied to the actuator.

The reinforcement learning algorithm can use an action space managing frequency selection, amplitude modulation, and pattern timing. The action space can define a set of possible actions that the reinforcement learning algorithm can select at each time step. Frequency selection can comprise choosing a vibration frequency from a range of available frequencies. Amplitude modulation can comprise adjusting a magnitude of vibrations generated by the actuator. Pattern timing can comprise controlling a duration and sequence of vibration pulses.

In some cases, the reinforcement learning algorithm can use Q-learning warm-started from exploration sweep data. As described above, the exploration sweep can generate a frequency-to-motion map that associates each tested frequency and amplitude combination with a corresponding motion response. The Q-learning algorithm can use the frequency-to-motion map as initial data to accelerate learning. Warm-starting the Q-learning algorithm from the exploration sweep data can reduce the number of training episodes required to achieve goal-directed behavior.

The reinforcement learning algorithm can use an epsilon-greedy exploration schedule that decays over time. The epsilon-greedy exploration schedule can balance exploration of new actions with exploitation of learned actions. An epsilon value can represent a probability of selecting a random action rather than a greedy action based on learned values. The epsilon value can start at a higher value, such as 1.0, representing fully random action selection. The epsilon value can decay over time toward a lower value, such as 0.05, representing mostly greedy action selection. The decaying epsilon schedule can allow the system to explore a wide range of actions early in training and progressively shift toward exploiting learned actions as training progresses.

In some aspects, the system can achieve qualitative goal-directed behavior in approximately 200 to 500 training episodes. Each training episode can comprise up to twenty vibration pulses. During each episode, the reinforcement learning algorithm can select actions from the action space, observe resulting motion of the system, and update learned values based on observed rewards.

The system can be trained in different goal modes to achieve different types of controlled movement. In some cases, the system can be trained in a forward goal mode. In the forward goal mode, an agent can attempt to maximize travel in a positive Y direction. The positive Y direction can correspond to a forward direction relative to an orientation of the computing device.

In some aspects, the system can be trained in a target goal mode. In the target goal mode, the agent can attempt to reach a fixed waypoint coordinate. The fixed waypoint coordinate can comprise an (x, y) position on a surface on which the system operates. The reinforcement learning algorithm can provide rewards based on progress toward the fixed waypoint coordinate.

In some cases, the system can be trained in a rotate goal mode. In the rotate goal mode, the agent can attempt to rotate in place without translating. The reinforcement learning algorithm can provide rewards for rotation while penalizing translation of the computing device.

The system can export per-step transition logs to a CSV file. The per-step transition logs can include state, action, reward, and next state for each step during training. The state can comprise position, velocity, and vibration parameters at a beginning of a step. The action can comprise actuation parameters selected by the reinforcement learning algorithm for the step. The reward can comprise a scalar value indicating performance of the action relative to a current goal mode. The next state can comprise position, velocity, and vibration parameters at an end of the step. The CSV file can be stored in a documents folder of the computing device and can be accessed for analysis of training performance.

A method for controlling locomotion of a robotic system can include generating, by an actuator of a computing device, vibrations at one or more actuation parameters. The vibrations can be transmitted to a plurality of leg structures of a platform mechanically coupled to the computing device to induce locomotion of the robotic system. The method can include capturing, by a camera of the computing device, image data during the locomotion. The method can include determining, by a processor of the computing device, a motion of the robotic system based on the image data. The method can include correlating the motion with the one or more actuation parameters. The method can include adjusting the one or more actuation parameters based on the correlation to achieve a desired locomotion.

In some aspects, the actuator can generate vibrations at one or more actuation parameters to induce locomotion of the robotic system. The actuator can be referred to herein as a vibration motor. The one or more actuation parameters can comprise at least one of a frequency, a duration, a magnitude, or a pattern timing of the vibrations. The frequency can define a rate at which the actuator oscillates during vibration generation. The duration can define a length of time for which a vibration is generated. The magnitude can define an amplitude or intensity of the vibration. The pattern timing can define a sequence or schedule of vibration pulses over time. In some cases, the one or more actuation parameters can comprise a combination of frequency, duration, magnitude, and pattern timing.

The vibrations generated by the actuator can be transmitted through the computing device and the platform to the plurality of leg structures. The plurality of leg structures can interact with a surface to produce locomotion when the actuator is activated. Different actuation parameters can produce different types of locomotion. In some cases, vibrations at a first frequency can produce forward movement, while vibrations at a second frequency can produce rotation. The relationship between actuation parameters and resulting motion can depend on a geometry of the plurality of leg structures and properties of a surface on which the robotic system operates.

The camera of the computing device can capture image data during the locomotion. In some aspects, the camera can comprise a front-facing camera of the computing device. The image data can comprise images of a reference pattern positioned above the robotic system. The reference pattern can comprise a checkerboard pattern positioned on a ceiling above the robotic system. The checkerboard pattern can provide features for a vision system to track in each frame captured by the front-facing camera.

The processor of the computing device can determine a motion of the robotic system based on the image data. The processor can process the image data to determine translation and rotation of the computing device. In some cases, the processor can determine a velocity of the robotic system based on changes in position between successive frames of image data. The processor can track cumulative translation of the computing device over time.

The method can include correlating the motion with the one or more actuation parameters. The correlation can establish a relationship between specific actuation parameters and resulting motion of the robotic system. In some aspects, the processor can generate a frequency-to-motion map that associates each tested frequency with a corresponding motion response. The frequency-to-motion map can record how much and in which direction the computing device moved in response to each vibration frequency. The processor can store the correlation data for use in subsequent locomotion control.

The method can include adjusting the one or more actuation parameters based on the correlation to achieve a desired locomotion. The desired locomotion can comprise forward movement, backward movement, turning left, turning right, or rotation in place. In some cases, the processor can select actuation parameters from the frequency-to-motion map that correspond to a desired direction of movement. The processor can modulate the frequency, duration, magnitude, or pattern timing of vibrations to achieve controlled movement toward a target location or orientation.

In some aspects, the method can implement a closed-loop control system in which the camera continuously captures image data during locomotion, the processor determines motion based on the image data, and the processor adjusts actuation parameters in response to observed motion. The closed-loop control system can enable the robotic system to correct for deviations from a desired trajectory. The processor can compare observed motion with desired motion and adjust actuation parameters to reduce the difference between observed and desired motion.

In some cases, the processor can adjust actuation parameters in real-time during locomotion to achieve a desired trajectory. The processor can receive a target location or orientation and can select and adjust actuation parameters to move the robotic system toward the target. The processor can continuously monitor position and motion of the robotic system through the camera and can make adjustments to actuation parameters as needed to maintain progress toward the target.

The method can include performing an exploration sweep to characterize the relationship between actuation parameters and resulting motion. The exploration sweep can comprise generating vibrations across a range of frequencies and recording a resulting motion for each frequency to generate a frequency-to-motion map. In some aspects, the exploration sweep can be performed across a vibration frequency range of 10 Hz to 300 Hz. The exploration sweep can be performed at two amplitudes to capture motion responses at different vibration intensities. During the exploration sweep, the actuator can generate vibrations at each frequency within the range, and the camera can capture image data to record the resulting motion of the robotic system.

Each vibration command during the exploration sweep can be played for approximately one second while recording the resulting motion. The processor can determine translation and rotation of the computing device based on the image data captured during each vibration command. The processor can record how much and in which direction the computing device moved in response to each vibration frequency and amplitude combination. In some cases, the exploration sweep can take approximately six minutes to complete. The duration of the exploration sweep can depend on the number of frequencies tested and the duration of each vibration command.

The frequency-to-motion map generated during the exploration sweep can associate each tested frequency and amplitude combination with a corresponding motion response. The frequency-to-motion map can record translation and rotation data for each vibration command tested during the exploration sweep. In some aspects, the processor can use the frequency-to-motion map to select actuation parameters that correspond to a desired direction of movement. The frequency-to-motion map can be saved to a configuration file. The configuration file can be reloaded for the same leg structure and surface combination, allowing the robotic system to skip the exploration sweep on subsequent uses.

In some aspects, adjusting the one or more actuation parameters can comprise executing a reinforcement learning algorithm to optimize the one or more actuation parameters. The reinforcement learning algorithm can comprise Proximal Policy Optimization (PPO). PPO can be selected for stability in continuous control tasks. The reinforcement learning algorithm can enable autonomous discovery and optimization of movement strategies through systematic experimentation.

The reinforcement learning algorithm can use a state space incorporating position, velocity, and vibration parameters. The state space can represent a current condition of the robotic system at each time step during training. The position can comprise a location of the computing device as determined based on image data captured by the camera. The velocity can comprise a rate of change of position of the computing device between successive frames of image data. The vibration parameters can comprise current or recent actuation parameters applied to the actuator.

The reinforcement learning algorithm can use an action space managing frequency selection, amplitude modulation, and pattern timing. The action space can define a set of possible actions that the reinforcement learning algorithm can select at each time step. Frequency selection can comprise choosing a vibration frequency from a range of available frequencies. Amplitude modulation can comprise adjusting a magnitude of vibrations generated by the actuator. Pattern timing can comprise controlling a duration and sequence of vibration pulses.

In some cases, the reinforcement learning algorithm can use Q-learning warm-started from exploration sweep data. The Q-learning algorithm can use the frequency-to-motion map as initial data to accelerate learning. Warm-starting the Q-learning algorithm from the exploration sweep data can reduce the number of training episodes required to achieve goal-directed behavior. The reinforcement learning algorithm can use an epsilon-greedy exploration schedule that decays over time. The epsilon-greedy exploration schedule can balance exploration of new actions with exploitation of learned actions. An epsilon value can represent a probability of selecting a random action rather than a greedy action based on learned values. The epsilon value can start at a higher value, such as 1.0, representing fully random action selection. The epsilon value can decay over time toward a lower value, such as 0.05, representing mostly greedy action selection.

In some aspects, the robotic system can achieve qualitative goal-directed behavior in approximately 200 to 500 training episodes. Each training episode can comprise up to twenty vibration pulses. During each episode, the reinforcement learning algorithm can select actions from the action space, observe resulting motion of the robotic system, and update learned values based on observed rewards.

The robotic system can be trained in different goal modes to achieve different types of controlled movement. In some cases, the robotic system can be trained in a forward goal mode. In the forward goal mode, an agent can attempt to maximize travel in a positive Y direction. The positive Y direction can correspond to a forward direction relative to an orientation of the computing device. In some aspects, the robotic system can be trained in a target goal mode. In the target goal mode, the agent can attempt to reach a fixed waypoint coordinate. The fixed waypoint coordinate can comprise an (x, y) position on a surface on which the robotic system operates. The reinforcement learning algorithm can provide rewards based on progress toward the fixed waypoint coordinate. In some cases, the robotic system can be trained in a rotate goal mode. In the rotate goal mode, the agent can attempt to rotate in place without translating. The reinforcement learning algorithm can provide rewards for rotation while penalizing translation of the computing device.

A non-transitory computer-readable medium can store instructions that, when executed by a processor of a computing device, cause the computing device to perform operations for controlling locomotion of a robotic system. The non-transitory computer-readable medium can comprise any suitable storage medium, including but not limited to RAM, EPROM, flash memory, optical drives, magnetic hard drives, or other media for storing electronic data. The instructions stored on the non-transitory computer-readable medium can be implemented in a high-level procedural or object-oriented programming language, or in assembly or machine language.

The instructions, when executed by the processor, can cause the computing device to control an actuator of the computing device to generate vibrations at one or more actuation parameters. As described above, the one or more actuation parameters can comprise at least one of a frequency, a duration, a magnitude, or a pattern timing of the vibrations. The vibrations can be transmitted to a plurality of leg structures of a platform mechanically coupled to the computing device to induce locomotion. The platform can comprise a smartphone case configured to receive a smartphone, and the plurality of leg structures can extend from the platform with each leg structure terminating at a leg tip configured to contact a surface.

The instructions can cause the computing device to receive image data from a camera of the computing device during the locomotion. The camera can comprise a front-facing camera of the computing device. The image data can comprise images of a reference pattern positioned above the robotic system. In some cases, the reference pattern can comprise a checkerboard pattern positioned on a ceiling above the robotic system.

The instructions can cause the computing device to determine a motion of the computing device based on the image data. The processor can process the image data to determine translation and rotation of the computing device. In some aspects, the processor can determine a velocity of the computing device based on changes in position between successive frames of image data. The processor can track cumulative translation of the computing device over time.

The instructions can cause the computing device to correlate the motion with the one or more actuation parameters. The correlation can establish a relationship between specific actuation parameters and resulting motion of the computing device. In some cases, the processor can generate a frequency-to-motion map that associates each tested frequency with a corresponding motion response. The frequency-to-motion map can record how much and in which direction the computing device moved in response to each vibration frequency.

The instructions can cause the computing device to adjust the one or more actuation parameters based on the correlation to achieve a desired locomotion. The desired locomotion can comprise forward movement, backward movement, turning left, turning right, or rotation in place. In some aspects, the processor can select actuation parameters from the frequency-to-motion map that correspond to a desired direction of movement. The processor can modulate the frequency, duration, magnitude, or pattern timing of vibrations to achieve controlled movement toward a target location or orientation.

In some aspects, the instructions can further cause the computing device to execute a reinforcement learning algorithm to optimize the one or more actuation parameters for achieving controlled movement. The reinforcement learning algorithm can comprise Proximal Policy Optimization (PPO). PPO can be selected for stability in continuous control tasks. The reinforcement learning algorithm can enable autonomous discovery and optimization of movement strategies through systematic experimentation.

The reinforcement learning algorithm can use a state space incorporating position, velocity, and vibration parameters. The state space can represent a current condition of the robotic system at each time step during training. The reinforcement learning algorithm can use an action space managing frequency selection, amplitude modulation, and pattern timing. The action space can define a set of possible actions that the reinforcement learning algorithm can select at each time step.

In some cases, the reinforcement learning algorithm can use Q-learning warm-started from exploration sweep data. The Q-learning algorithm can use the frequency-to-motion map as initial data to accelerate learning. The reinforcement learning algorithm can use an epsilon-greedy exploration schedule that decays over time. The epsilon-greedy exploration schedule can balance exploration of new actions with exploitation of learned actions.

The instructions can cause the computing device to implement a closed-loop control system in which the camera continuously captures image data during locomotion, the processor determines motion based on the image data, and the processor adjusts actuation parameters in response to observed motion. The closed-loop control system can enable the robotic system to correct for deviations from a desired trajectory.

While the disclosed examples reference a smartphone as the computing device, the disclosed technology is not limited to smartphones. The self-learning robotic system can be extended to other applications where moving an object through vibration-induced locomotion can be desirable.

In some aspects, the computing device can comprise a portable computing device other than a smartphone. The portable computing device can comprise a tablet computer. The tablet computer can include an actuator capable of generating vibrations, a camera for capturing image data, and a processor for executing instructions to control locomotion. A platform can be mechanically coupled to the tablet computer, with the platform comprising a plurality of leg structures extending therefrom. The larger form factor of a tablet computer can provide additional surface area for leg structure attachment and can accommodate larger or more numerous leg structures.

In some cases, the computing device can comprise a specialized robotic platform. The specialized robotic platform can be designed for specific applications where vibration-induced locomotion can be advantageous. The specialized robotic platform can include a dedicated actuator, a camera or other sensor for position tracking, and a processor configured to execute instructions for controlling locomotion. The specialized robotic platform can be configured to operate in environments where wheeled or legged locomotion mechanisms can be less effective.

In some aspects, the disclosed technology can be applied to drug delivery systems. Vibration-induced locomotion can be used to move objects through small-scale environments, such as pipes or channels within a body. A micro-scale robotic device can include an actuator configured to generate vibrations, a sensor for position tracking, and a plurality of leg structures or bristle-like appendages configured to contact surfaces within the small-scale environment. The micro-scale robotic device can use vibration-induced locomotion to navigate through confined spaces where other locomotion mechanisms can be impractical.

In some cases, the disclosed technology can be applied to micro-scale robotic devices. At small scales, vibration-induced locomotion can be effective for achieving controlled movement. A micro-scale robotic device can include an actuator, a sensor for determining position or motion, and leg structures configured to interact with a surface. The micro-scale robotic device can implement the disclosed methods for correlating motion with actuation parameters and adjusting actuation parameters to achieve desired locomotion.

In some aspects, the disclosed technology can be applied to payload transport platforms. A payload transport platform can comprise a platform configured to carry a payload, with the platform including an actuator, a camera or sensor for position tracking, and a plurality of leg structures extending from the platform. The actuator can generate vibrations that are transmitted to the leg structures to induce locomotion of the payload transport platform. The payload transport platform can use the disclosed methods for determining motion based on image data, correlating motion with actuation parameters, and adjusting actuation parameters to achieve controlled movement toward a target location.

In some cases, the computing device can comprise a wearable computing device. The wearable computing device can include an actuator, a camera or sensor, and a processor. A platform with leg structures can be mechanically coupled to the wearable computing device to enable vibration-induced locomotion.

Any device incorporating an actuator capable of generating vibrations, a camera or sensor for position tracking, and leg structures for surface contact can implement the disclosed technology. The actuator can be configured to generate vibrations at one or more actuation parameters. The camera or sensor can be configured to capture data for tracking a location or motion of the device during operation. The leg structures can be configured to contact a surface and to respond to vibrations generated by the actuator to produce locomotion. A processor can be configured to determine motion based on data from the camera or sensor, correlate the motion with actuation parameters, and adjust actuation parameters to achieve desired locomotion.

In some aspects, the disclosed technology can be implemented using alternative position tracking mechanisms. While the disclosed examples describe using a camera to capture image data of a reference pattern for position tracking, other sensors can be used for position tracking in alternative embodiments. The sensor can comprise an inertial measurement unit (IMU) including an accelerometer and a gyroscope, or individual accelerometers or gyroscopes, or other sensors capable of determining position or motion of the device. When an accelerometer or IMU is used for position tracking, a reference pattern such as a checkerboard pattern may not be required, as the accelerometer or IMU can determine motion based on inertial measurements rather than visual features. In some cases, the system can combine camera-based tracking with accelerometer or IMU-based tracking to improve position tracking accuracy and learning performance. The processor can determine motion based on data from the sensor or combination of sensors and can correlate the motion with actuation parameters.

In some cases, the disclosed technology can be implemented using alternative actuator types. While the disclosed examples describe using a vibration motor or Taptic Engine as the actuator, other actuators capable of generating vibrations can be used. The actuator can comprise a piezoelectric actuator, an electromagnetic actuator, or other actuator types capable of generating vibrations at controlled frequencies and amplitudes. The vibrations generated by the actuator can be transmitted to the leg structures to induce locomotion.

### The disclosed technology can be further understood according to the following clauses

Clause 1: A self-learning robotic system, comprising: a computing device comprising an actuator and a camera; a platform mechanically coupled to the computing device, the platform comprising a plurality of leg structures extending therefrom, each leg structure terminating at a leg tip configured to contact a surface; wherein the actuator is configured to generate vibrations at one or more actuation parameters, the vibrations being transmitted to the plurality of leg structures to induce locomotion of the system; and wherein the camera is configured to capture image data for tracking a location of the computing device during operation.

Clause 2: The self-learning robotic system of clause 1, wherein the computing device comprises a processor configured to execute instructions to: determine a motion of the system based on the image data captured by the camera; correlate the motion with the one or more actuation parameters; and adjust the one or more actuation parameters based on the correlation to achieve a desired locomotion.

Clause 3: The self-learning robotic system of clause 2, wherein the processor is configured to execute a reinforcement learning algorithm to optimize the one or more actuation parameters for achieving controlled movement.

Clause 4: The self-learning robotic system of clause 3, wherein the reinforcement learning algorithm comprises Proximal Policy Optimization.

Clause 5: The self-learning robotic system of clause 2, wherein the one or more actuation parameters comprise at least one of a frequency, a duration, a magnitude, or a pattern timing of the vibrations.

Clause 6: The self-learning robotic system of clause 1, wherein the computing device comprises a smartphone and the platform comprises a smartphone case configured to receive the smartphone.

Clause 7: The self-learning robotic system of clause 6, wherein the actuator comprises a vibration motor of the smartphone.

Clause 8: The self-learning robotic system of clause 1, wherein the plurality of leg structures are configured to respond to predetermined vibrational frequencies to enable different types of movement.

Clause 9: The self-learning robotic system of clause 8, wherein the plurality of leg structures are configured to exploit multiple resonant modes between 10 Hz and 300 Hz.

Clause 10: The self-learning robotic system of clause 1, wherein the plurality of leg structures comprise at least one of straight leg structures, curved leg structures, angled leg structures, or branched leg structures.

Clause 11: The self-learning robotic system of clause 1, wherein a geometry of the plurality of leg structures affects a type of locomotion produced in response to the vibrations.

Clause 12: The self-learning robotic system of clause 1, wherein the camera comprises a front-facing camera of the computing device, and wherein the image data comprises images of a reference pattern positioned above the system.

Clause 13: The self-learning robotic system of clause 1, further comprising a vision module configured to process the image data using at least one of optical flow analysis or feature-based tracking to determine position and motion of the system.

Clause 14: The self-learning robotic system of clause 1, wherein the computing device further comprises an accelerometer, and wherein the accelerometer is configured to capture motion data for tracking a location of the computing device during operation.

Clause 15: The self-learning robotic system of clause 14, wherein the processor is configured to determine the motion of the system based on data from both the camera and the accelerometer.

Clause 16: A method for controlling locomotion of a robotic system, comprising: generating, by an actuator of a computing device, vibrations at one or more actuation parameters, the vibrations being transmitted to a plurality of leg structures of a platform mechanically coupled to the computing device to induce locomotion of the robotic system; capturing, by a camera of the computing device, image data during the locomotion; determining, by a processor of the computing device, a motion of the robotic system based on the image data; correlating the motion with the one or more actuation parameters; and adjusting the one or more actuation parameters based on the correlation to achieve a desired locomotion.

Clause 17: The method of clause 16, further comprising: performing an exploration sweep comprising generating vibrations across a range of frequencies and recording a resulting motion for each frequency to generate a frequency-to-motion map.

Clause 18: The method of clause 16, wherein adjusting the one or more actuation parameters comprises executing a reinforcement learning algorithm to optimize the one or more actuation parameters.

Clause 19: The method of clause 18, wherein the reinforcement learning algorithm uses a state space incorporating position, velocity, and vibration parameters, and an action space managing frequency selection, amplitude modulation, and pattern timing.

Clause 20: The method of clause 16, wherein the one or more actuation parameters comprise at least one of a frequency, a duration, a magnitude, or a pattern timing of the vibrations.

Clause 21: A non-transitory computer-readable medium storing instructions that, when executed by a processor of a computing device, cause the computing device to: control an actuator of the computing device to generate vibrations at one or more actuation parameters, the vibrations being transmitted to a plurality of leg structures of a platform mechanically coupled to the computing device to induce locomotion; receive image data from a camera of the computing device during the locomotion; determine a motion of the computing device based on the image data; correlate the motion with the one or more actuation parameters; and adjust the one or more actuation parameters based on the correlation to achieve a desired locomotion.

Clause 22: The non-transitory computer-readable medium of clause 21, wherein the instructions further cause the computing device to execute a reinforcement learning algorithm to optimize the one or more actuation parameters for achieving controlled movement.

Machine readable storage including machine-readable instructions, when executed, to implement a method or realize an apparatus in any of the examples of the present application.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. The eNB (or other base station) and UE (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or an interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

What is claimed is:

1. A self-learning robotic system, comprising:
a computing device comprising an actuator and a camera;
a platform mechanically coupled to the computing device, the platform comprising a plurality of leg structures extending therefrom, each leg structure terminating at a leg tip configured to contact a surface;
wherein the actuator is configured to generate vibrations at one or more actuation parameters, the vibrations being transmitted to the plurality of leg structures to induce locomotion of the system; and
wherein the camera is configured to capture image data for tracking a location of the computing device during operation.

2. The self-learning robotic system of claim 1, wherein the computing device comprises a processor configured to execute instructions to:
determine a motion of the system based on the image data captured by the camera;
correlate the motion with the one or more actuation parameters; and
adjust the one or more actuation parameters based on the correlation to achieve a desired locomotion.

3. The self-learning robotic system of claim 2, wherein the processor is configured to execute a reinforcement learning algorithm to optimize the one or more actuation parameters for achieving controlled movement.

4. The self-learning robotic system of claim 3, wherein the reinforcement learning algorithm comprises Proximal Policy Optimization.

5. The self-learning robotic system of claim 2, wherein the one or more actuation parameters comprise at least one of a frequency, a duration, a magnitude, or a pattern timing of the vibrations.

6. The self-learning robotic system of claim 1, wherein the computing device comprises a smartphone and the platform comprises a smartphone case configured to receive the smartphone.

7. The self-learning robotic system of claim 6, wherein the actuator comprises a vibration motor of the smartphone.

8. The self-learning robotic system of claim 1, wherein the plurality of leg structures are configured to respond to predetermined vibrational frequencies to enable different types of movement.

9. The self-learning robotic system of claim 8, wherein the plurality of leg structures are configured to exploit multiple resonant modes between 10 Hz and 300 Hz.

10. The self-learning robotic system of claim 1, wherein the plurality of leg structures comprise at least one of straight leg structures, curved leg structures, angled leg structures, or branched leg structures.

11. The self-learning robotic system of claim 1, wherein a geometry of the plurality of leg structures affects a type of locomotion produced in response to the vibrations.

12. The self-learning robotic system of claim 1, wherein the camera comprises a front-facing camera of the computing device, and wherein the image data comprises images of a reference pattern positioned above the system.

13. The self-learning robotic system of claim 1, further comprising a vision module configured to process the image data using at least one of optical flow analysis or feature-based tracking to determine position and motion of the system.

14. The self-learning robotic system of claim 1, wherein the computing device further comprises an accelerometer, and wherein the accelerometer is configured to capture motion data for tracking a location of the computing device during operation.

15. The self-learning robotic system of claim 14, wherein the processor is configured to determine the motion of the system based on data from both the camera and the accelerometer.

16. A method for controlling locomotion of a robotic system, comprising:
generating, by an actuator of a computing device, vibrations at one or more actuation parameters, the vibrations being transmitted to a plurality of leg structures of a platform mechanically coupled to the computing device to induce locomotion of the robotic system;
capturing, by a camera of the computing device, image data during the locomotion;
determining, by a processor of the computing device, a motion of the robotic system based on the image data;
correlating the motion with the one or more actuation parameters; and
adjusting the one or more actuation parameters based on the correlation to achieve a desired locomotion.

17. The method of claim 16, further comprising:
performing an exploration sweep comprising generating vibrations across a range of frequencies and recording a resulting motion for each frequency to generate a frequency-to-motion map.

18. The method of claim 16, wherein adjusting the one or more actuation parameters comprises executing a reinforcement learning algorithm to optimize the one or more actuation parameters, wherein the reinforcement learning algorithm uses a state space incorporating position, velocity, and vibration parameters, and an action space managing frequency selection, amplitude modulation, and pattern timing.

19. The method of claim 16, wherein the one or more actuation parameters comprise at least one of a frequency, a duration, a magnitude, or a pattern timing of the vibrations.

20. A non-transitory computer-readable medium storing instructions that, when executed by a processor of a computing device, cause the computing device to:
control an actuator of the computing device to generate vibrations at one or more actuation parameters, the vibrations being transmitted to a plurality of leg structures of a platform mechanically coupled to the computing device to induce locomotion;
receive image data from a camera of the computing device during the locomotion;
determine a motion of the computing device based on the image data;
correlate the motion with the one or more actuation parameters; and
adjust the one or more actuation parameters based on the correlation to achieve a desired locomotion.
